(19) United States
(12) Patent Application Publication
(10) Pub. No.: US 2003/0038437 A1
(43) Pub. Date: Feb. 27, 2003

(54) Portable reverse drive

(76) Inventor: Joseph Leslie Ungvari, Roseville, CA (US)

Correspondence Address: Joseph L. Ungvari, 1600 Vista Creek Drive, Roseville, CA, 95661, US

(21) Appl. No.: 09/935,108

(22) Filed: Aug. 23, 2001

(51) Int. Cl. B62B 1/00

(52) U.S. Cl. 280/79.4

(57) ABSTRACT

A portable device which can be carried in a saddlebag or storage compartment that provides a motorcycle or other vehicle with a reverse drive capability. To use the devise, the rider need only place the device in front of the drive wheel. When the motorcycle is driven onto the invention, the clockwise rotation of the motorcycle's rear wheel imparts an opposite rotation on the rollers in contact with the roadway surface, which causes the motorcycle to move backward. After backing into the desired location, the rider disengages the clutch and can then roll off the device.

### BACKGROUND

1. Field of Invention

The field of invention relates to reverse drive mechanisms for motorcycles or other vehicles without the capability to provide reverse power to the drive wheel(s).

2. Description of Prior Art

The Portable Reverse Drive invention addressed herein can be used for motorcycles or any vehicle which has one or more drive wheels. For simplicity of presentation, the invention will be discussed in terms of providing reverse drive for a motorcycle. This convention is not intended to imply any limitations on the use of the invention for vehicles other than motorcycles.

Another convention used in this specification will be to describe the invention as a portable device. Although the device as shown in the drawings is portable, it can be attached to a motorcycle or vehicle and either manually or electrically lowered into position and raised as required. This convention is not intended to imply any limitations on the use of the invention as a non-portable device.

Reverse drive mechanisms have been available for many years on most automobiles, farm and recreational vehicles and a few motorcycles. Motorcycles are typically powered by a gasoline engine which is connected to and integrated with a multi-gear transmission. The transmission is connected to the rear wheel by a chain, belt or direct drive which transfers the power produced by the engine to the rear wheel and propels the motorcycle.

The transmission is generally designed with several sets of gears which enable the rider to shift at appropriate times to gain the speeds required to effectively travel on the road. The vast majority of motorcycles do not have transmissions which provide reverse drive capabilities for moving the motorcycle backwards. To move the motorcycle backwards, the rider must disengage the clutch, or place the transmission into neutral, and manually walk the motorcycle backward. The ease or difficulty experienced when executing this maneuver depends on the surface features of the roadway, the size and weight of the motorcycle and physical capabilities of the rider. Although this maneuver may not be difficult when the surface of the roadway is level, or when dealing with a small or lightweight motorcycle, when a large heavy motorcycle has to be moved backward uphill, it can be challenging or impossible without assistance form others. This problem has become more prevalent with the increased popularity of large motorcycles in recent years.

The present invention addresses this problem by providing an easy to use, portable mechanism, which can be used on virtually any motorcycle to move the motorcycle backwards. To use the device, the rider merely needs to place it, or have it placed by another rider, in front of the rear wheel of the motorcycle. The rider then engages the motorcycle's forward gear, rides up on the device, and powers backward. Once the rear tire is on the device, the forward clockwise rotation of the motorcycle's rear wheel, imparts a counterclockwise rotation, in the opposite direction to the tire, on the rollers in contact with the roadway surface, which causes the motorcycle to move backward. Once the motorcycle has been moved to the desired location, the rider disengages the clutch and rolls off the device.

Throughout the years, a number of innovations have been developed relating to reverse drive mechanisms, and the following U.S. patents are representative of some of those innovations: U.S. Pat. Nos. 6,267,192; 5,394,764; 4,974,695, 4,869,332; 4,763,538; and 4,523,491. All of these patents involve devices that are attached to or integrated into the drive train of the motorcycle, or employ a separate electric motor which is mounted on the motorcycle and are moved against a wheel to provide reverse drive. One such device is described in U.S. Pat. No. 6,267,192, to Josef Maier, August Schaeffler and Mike Hubertz. This device is designed to be mounted as a replacement starting motor, which provides both forward and reverse power to the flywheel through an electric motor. Also mounted on the motorcycle is a control device that is manually operated by the rider to select the operating function desired. Similarly, the device in U.S. Pat. No. 5,394,764, to Anthony W. Fini, Jr. provides for a bevel gear mechanism which can be mounted in the driveline of a motorcycle and is manually controlled by levers. In the device disclosed in U.S. Pat. No. 4,869,332, a starter motor and complex gear assembly is mounted into the driveline of the motorcycle and provides reverse power. U.S. Pat. No. 4,763,538, to Haruyasu Fujita, Yoshianki Hirosawa and Toshifumi Ito, and U.S. Pat. No. 4,523,491, to Fred M. Dittmann, Jr. also disclose complex transmission type devices that are installed into the driveline of the motorcycle and provide reverse power.

Although these devices achieve the desired result, a device that accomplishes the same result without the need for extensive modifications to the motorcycle would be more desirable. The present invention has several advantages over previously developed reverse drive mechanisms. First, it does not require the rider to perform any modifications to his motorcycle. Although it can be attached, it need not be attached to any part of the motorcycle and it does not have levers or control switches that need to be installed to work. It is completely portable and a single unit can be used to provide reverse power for any number of motorcycles or vehicles. It can built to accommodate any size tire by increasing or decreasing the width, length and height of the device, thereby providing the capability to be used for virtually any style motorcycle. It is easily operated; one only needs to place it on the ground in front of the rear wheel, and picked up after use. Also, it is a very simple device, which helps to maximizes reliability and minimizes the need for maintenance. Finally, the device is small enough to be carried in most saddlebags and can be easily handled by the smallest and frailest of riders.

### OBJECTS AND ADVANTAGES

Thus, while the foregoing body of prior art discloses several devices that can be installed or utilized on a motorcycle which provide reverse drive, the prior art described above does not teach or suggest a device which has the following combination of desirable features: (1) the device does not require any modifications to the motorcycle; (2) the devise need not me mounted into the driveline or on the motorcycle; (3) the device is portable; (4) it is a simple design with minimal moving parts, to maximize reliability and minimize maintenance; (5) is easily operated; and (6) can be manufactured to fit virtually any motorcycle. The foregoing desired characteristics are provided by the Portable Reverse Drive as will be made apparent from the following description. Other advantages of the invention over the prior art will also be rendered evident.

### DESCRIPTION OF THE DRAWINGS

The following description of the drawings will assist in better understanding the invention. The descriptions below makes reference to the drawings annexed herein:

FIG. 1 is a three-dimensional view of the invention as fully assembled.

FIG. 2 and 2A shows the component parts of the invention shown in FIG. 1.

FIG. 3 shows how the invention works.

### REFERENCE NUMERALS IN DRAWING

Following is a list of the referenced numerals in the drawings:

| Number | Description |
|---|---|
| 1 | Frame |
| 2 | Roller |
| 3 | Axle |
| 4 | Axle Nut |
| 5 | Spacer |
| 6 | Bearing |
| 7 | Tire |

### SUMMARY OF THE INVENTION

To achieve the foregoing and other advantages, the present invention provides a motorcycle with reverse drive capability. This portable device can be carried along in a saddlebag or storage compartment and only needs to be placed in front of the drive wheel to provide reverse drive capability. When the motorcycle is driven onto the invention, the clockwise rotation of the motorcycle's rear wheel imparts an opposite rotation on the rollers in contact with the roadway surface, which causes the motorcycle to move backward. After the motorcycle has been moved to the desired location, the rider only needs to disengage the motorcycle's clutch and roll off of the invention.

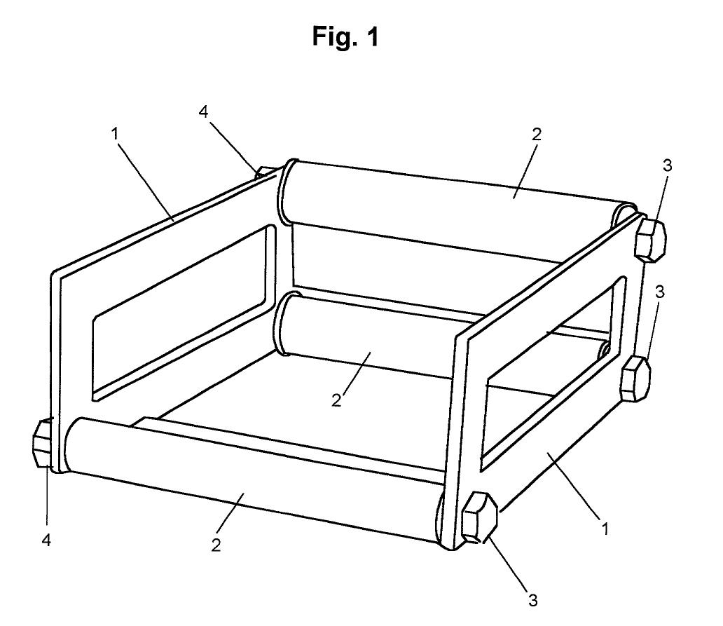

### DESCRIPTION AND OPERATION—FIGS. 1-3

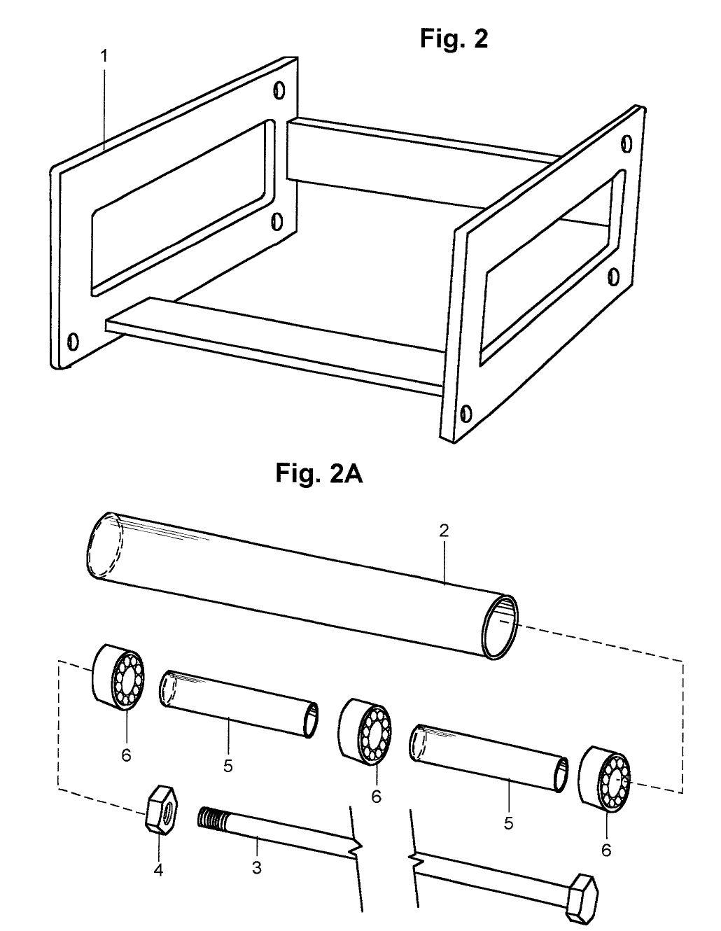

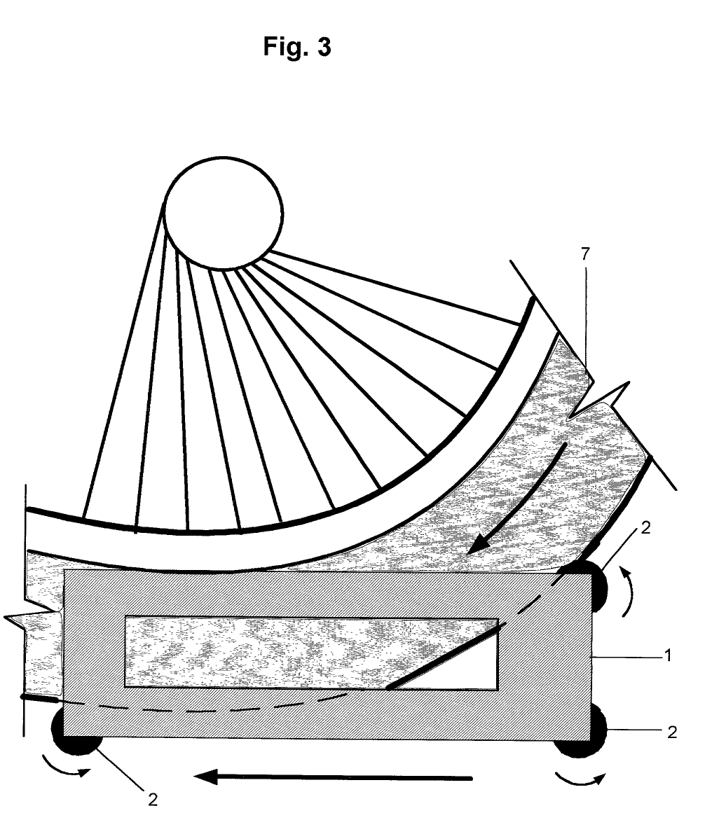

The typical embodiment of the invention is illustrated in FIG. 1. FIGS. 2 and 2A show each of the unassembled pieces that comprise the invention. FIG. 3 shows the invention as it would be used to provide reverse drive for a motorcycle or vehicle.

As shown, the Portable Reverse Drive (FIG. 1) is comprised of a frame 1 and three roller assemblies. Each roller assembly (FIG. 2A) is comprised of a roller 2, axle 3, axle nut 4, spacers 5, and bearings 6. FIG. 2A shows three bearings 6 and two spacers 5; however, the components of the roller assembly (FIG. 2A) may be designed with various combinations of bearings 6 and spacers 5 to provide sufficient stability and capacity to carry anticipated loads. Also, the invention may be produced in various sizes to accommodate any size tire.

The operation of the device is straight-forward. FIG. 3 shows the invention as it is used to provide reverse drive capability. When deployed, the tire 7 is rotating in a clockwise direction, which would normally propel the motorcycle in a forward direction. The clockwise rotation of the tire 7 imparts a counterclockwise rotation on the rollers 2, which propels the motorcycle or vehicle in the reverse direction.

To use the invention the rider places the invention in front of the rear wheel of a motorcycle. The rider then drives forward, first up onto the invention, and then as power is transmitted to the rollers 2, the motorcycle is propelled backward to the desired location. To get off the invention, the rider simply disengages the clutch, or shifts the motorcycle into neutral, and rolls backward. Once off the invention, it can be picked up and stored.

### CONCLUSIONS, RAMIFICATIONS AND SCOPE

As shown above, the invention can be used as a portable but effective means to provide reverse drive capability for motorcycles that are not equipped with reverse drive capability. The primary advantage over prior art is that the invention is portable and requires no modifications to a motorcycle or vehicle to be effective. Other advantages are that it is simple in design and operation, easily used, and can be sized to fit any application.

The above brief description sets forth rather broadly the more important features of the present invention so that the detailed descriptions may be better understood, and the contributions to the art may be better appreciated. There may be additional features of the invention that will be documented hereafter and for the subject matter of the claims appended hereto. In this respect, the intension is not to limit the invention in its application to the details of the construction and to the arrangements of the components set forth in the above description or illustrated in the drawings. The invention is capable of other embodiments and of being practiced and carried out in various ways. Also, the phraseology and terminology employed herein are for the purpose of description and should not be regarded as limiting. As such, the intent is that those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Finally, the purpose of the Abstract provided at the end of this specification is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A device that provides reverse drive capability for motorcycles and vehicles with one or more drive wheels, comprising:
(a) A frame which is constructed to accommodate roller assemblies, and
(b) Roller assemblies which are attached to the frame and are configured to translate, in an opposite direction, the rotational force of a tire upon the ground surface.

2. The device of claim 1 which is designed to be portable.

3. A device for motorcycles or vehicles which provides reverse drive capabilities, comprising:
(a) a rigid frame which is configured to accommodate two or more roller assemblies, and
(b) roller assemblies which are attached to the frame comprising:
1. an axle which attaches the roller assembly to the frame, and
2. a roller comprised of a cylindrical tube, which is mounted on the axle, and
3. bearings, which are mounted on the axle and situated inside the roller, and
4. spacers, which are mounted on the axle and situated inside the roller.

4. The device of claim 3 which is designed to be portable.

5. A device for motorcycles or vehicles which provides reverse drive capabilities, comprising:
(a) a rigid frame which is configured to accommodate two or more roller assemblies, and
(b) roller assemblies which are attached to the frame comprising:
1. a solid roller which is attached to the frame, and
2. bearings, which are mounted between the roller and frame such that the said roller is capable of rotating independent of the frame.
